(19) United States
(12) Patent Application Publication
(10) Pub. No.: US 2024/0354995 A1
(43) Pub. Date: Oct. 24, 2024

(54) COMPRESSION OF LIDAR POINTCLOUD

(71) Applicant: GM Cruise Holdings LLC, San Francisco, CA (US)

(72) Inventors: Roger Curley, Rockville, MD (US); Meng-Ta Chou, Richmond, CA (US)

(21) Appl. No.: 18/306,177

(22) Filed: Apr. 24, 2023

(51) Int. Cl. G06T 9/00; G01S 7/481; G01S 17/89; G01S 17/931

(52) U.S. Cl. CPC G06T 9/00; G01S 7/4815; G01S 17/89; G01S 17/931

(57) ABSTRACT

Aspects of the disclosed technology provide solutions for compressing a point cloud of LiDAR data collected for autonomous vehicle (AV) navigation. A process of the disclosed technology can include steps for receiving point cloud data from a LiDAR sensor coupled to an AV, formatting a portion of the received point cloud data according to a raster graphic-image file standard to create a data frame, and compressing the data frame using a lossless compression algorithm. Systems and machine-readable media are also provided.

### BACKGROUND

### 1. Technical Field

The present disclosure generally relates to handling of point cloud data generated by a Light Detection and Ranging (LiDAR) sensor as an input to a navigation system on an autonomous vehicle (AV) navigation.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions conventionally performed by human drivers, such as performing navigation and routing tasks necessary to provide a safe and efficient transportation. Such tasks may require the collection and processing of large quantities of data using various sensor types, including but not limited to cameras and/or Light Detection and Ranging (LiDAR) sensors disposed on the AV. In some instances, the collected data can be used by the AV to perform tasks relating to routing, planning, and obstacle avoidance.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates exemplary coordinate systems within an AV environment, according to some aspects of the disclosed technology.

FIG. 2 depicts an exemplary environment around an AV, according to some aspects of the disclosed technology.

FIG. 3 illustrates an exemplary LiDAR system, according to some aspects of the disclosed technology.

FIG. 4 illustrates an exemplary data frame that comprises data generated by a LiDAR system, according to some aspects of the disclosed technology.

FIGS. 5A-5E illustrate a second exemplary data structure of LiDAR data, according to some aspects of the disclosed technology.

FIG. 6 illustrates an exemplary processor-based system, according to some aspects of the disclosed technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Some aspects of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

Autonomous vehicle (AV) navigation systems require information about the surrounding environment in order to avoid objects/entities as well as navigate through the environment. It is additionally useful to verify the correlation of an internal virtual navigation model with the physical world. One sensor used to detect objects is a LiDAR sensor, which typically emits multiple laser beams and detects reflections of the beams from objects. By measuring the direction of the emitted beam and the time interval between emitting the beam and receiving the reflection, the system determines a position of the sensed object surface in 3D space relative to the sensor. Each measurement of a point in space includes the position in space (the x,y,z coordinates) as well as other data, for example the reflectance of the object. A typical LiDAR sensor on an AV may measure over 100,000 points per rotation surrounding the AV. The data associated with a single measurement of a single point is called a “point data set.” A dataset of single measurements of all points in a single revolution is called a “point cloud” although this term may also be used to refer to data sets from multiple revolutions of the sensor. A typical AV navigation LiDAR will produce a stream of point cloud data at a rate of approximately 100 megabits per second (Mbps). This amount of data presents challenges in both storage, consuming approximately 50 gigabytes (GB) per hour of driving, and transmission bandwidth. In certain embodiments, data compression is performed on the car prior to sending this data stream from the car to a remote management system. In certain embodiments, data compression is performed on the car prior to storing the data locally for later download. In certain embodiments, data compression is performed after the data is received or downloaded from the car, e.g., prior to archiving or transfer to an analysis program.

To reduce storage and bandwidth requirements, data can be compressed. Data compression methodologies are characterized as “lossless” and “lossy.” An algorithm is considered “lossless” if the original data can be reconstructed from the compressed data with no significant loss of information. No compression algorithm can efficiently compress all possible data without losing some data. Compression algorithms are therefore designed with a specific type of input data in mind or with specific assumptions about what kinds of redundancy the uncompressed data are likely to contain. It is important in AV navigation to be able to reconstruct the original point cloud data from the compressed data with no significant loss of information, so a lossless data compression method is necessary.

In computer graphics and digital photography, a “raster graphic” represents a two-dimensional (2D) picture as a rectangular matrix of square pixels. The term “raster” is derived from the Latin “rastrum” (a rake) and was first used to describe the line-by-line scanning of a cathode ray tube (CRT) video monitor with an electron beam to create the screen image. A single numeric value is typically stored for each pixel, e.g., a color value having 24 bits (over 16 million distinct colors), with 8 bits (values 0-255) for each color channel (red, green, and blue), although the single value can be concatenated from any data. The image is then stored in a raster-graphic format, which also comprises a header containing the number of columns and other metadata.

Portable Network Graphics (PNG) is a raster-graphic file format that supports lossless data compression. Data that is formatted according to this standard can be compressed using a lossless data compression algorithm, for example involving a combination of LZ77 and Huffman coding. Lossless compression algorithms for PNG files are publicly available and the PNG format is widely supported by commercial software tools.

Tag Image File Format (TIFF) is another raster-graphic file format used to store raster graphics and image information. TIFF is suited for high-resolution images and is a favorite format among photographers and desktop publishing as it also supports lossless data compression.

The systems and methods disclosed herein format the point cloud data from a LiDAR sensor into a raster-graphic data frame and then compress the data frame using a lossless algorithm. Comparison tests have shown an 80% reduction in average file size.

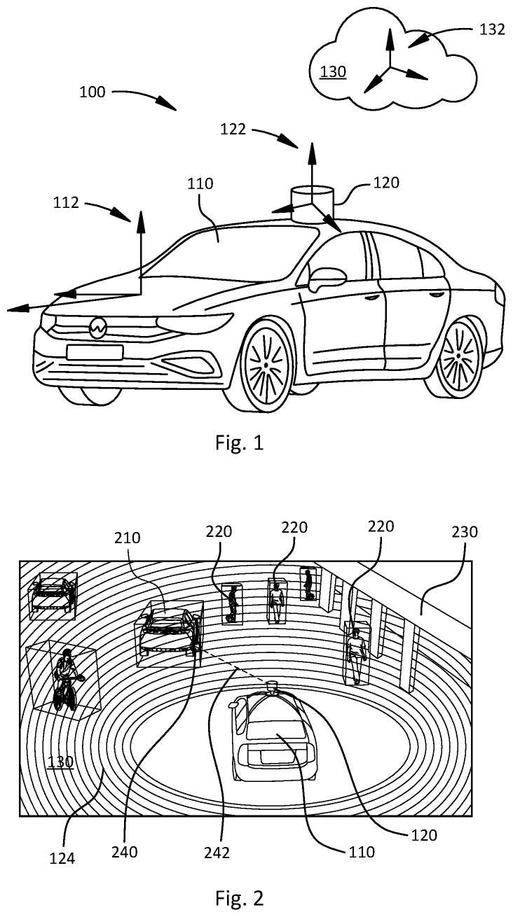

FIG. 1 illustrates exemplary system 100 comprising coordinate systems 112, 122, 132 within an AV environment 130, according to some aspects of the disclosed technology. In this example, a LiDAR sensor 120, for example a Pandar64 from Datron Technology, is fixedly attached to the roof of an AV 110. The LiDAR sensor 120 has a coordinate system 122 defined relative to the housing that is fixedly attached to the AV 110.

Within the column, The LiDAR sensor 120 comprises a vertical array of rangefinders, e.g., lasers that emit a beam of light along a vector defined in the coordinate system 122. In certain embodiments, each laser has a fixed attitude, e.g., a vertical angle of the laser. If the beam of light encounters a surface, a portion of the emitted light is reflected toward the LiDAR sensor 120. The LiDAR sensor 120 detects the reflected light and determines the time-of-flight of the light beam from emission to detection, which can be converted to a distance of the reflecting surface from the LiDAR sensor 120. Detection of the reflected light signifies that a point of interest exists proximate to the AV 110. The distance to the point and the position & orientation of the vertical array of the LiDAR sensor 120 in the first coordinate system are saved as a point data set associated with the point of interest. In certain embodiments, the LiDAR sensor 120 records the azimuth (horizontal angle of the laser column) along with the returns for each of the column. In certain embodiments, the point data set includes other information, e.g., the reflectance of the surface at the point, the RGB color values of the reflecting surface, or the time of the capture of the information of the point data set.

The AV 110 has a coordinate system 112 fixedly defined with respect to the chassis of the AV 110. In certain embodiments, the 3D position of the point of interest is transformed from the coordinate system 122 of the LiDAR sensor 120 into the coordinate system 112 of the AV 110.

The AV 100 moves within an environment 130, e.g., the physical world, e.g., a community having fixed items, e.g., streets and buildings, and mobile items, e.g., vehicles, pedestrians, or bicyclists. The environment 130 has a coordinate system 132 fixedly defined with respect to the physical world. In certain embodiments, the environment 130 comprises a virtual model of the physical world and the coordinate system 132 is fixedly defined in the virtual world as well. In certain embodiments, the 3D position of the point of interest is transformed from the coordinate system 112 of the AV 110 into the coordinate system 132 of the environment 130.

In certain embodiments, the position and orientation of the LiDAR sensor 120 in the coordinate system 112 of the AV 110 is provided separately. In certain embodiments, the position and orientation of the AV 110 in the coordinate system 132 of the environment 130 at the time of the capture of the point data set is provided separately.

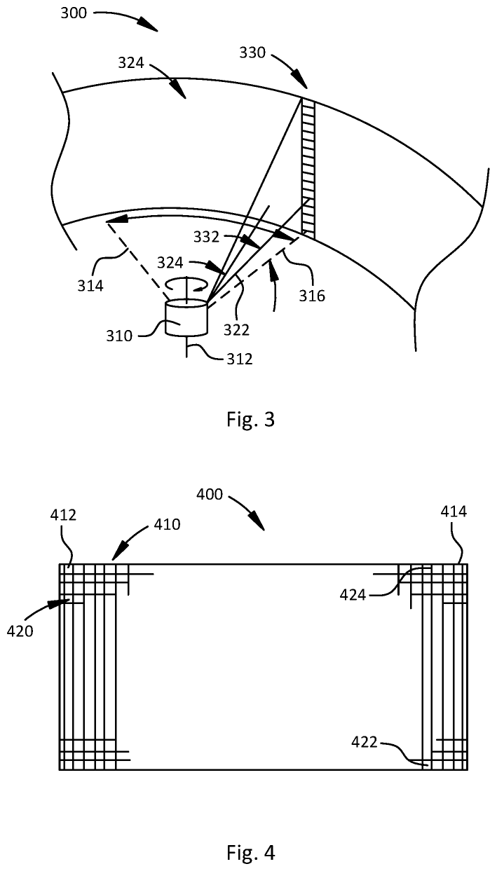

The transform from the coordinate system 112 to the coordinate system 132 is a function of the AV's position and orientation in the environment 130. This transformation changes over time as the AV travels a significant distance over the timescale of a LiDAR sensor rotation. In certain embodiments, a different transform is applied to groups of measurements, e.g., the data collected at 6 incremental rotational positions of the LiDAR 120. The data structure is discussed further with respect to FIGS. 3-4.

FIG. 2 depicts an exemplary environment 130 around an AV 110, according to some aspects of the disclosed technology. The environment 130 comprises one or more vehicles 210, pedestrians 220, and static objects 230, e.g., a building. The circles 124 represent the light emitted by the LiDAR sensor 120. In certain embodiments, the environment 130 is a virtual model.

Point 240 is an example location where a light beam 242 emitted by the LiDAR sensor 120 encounters a surface, e.g., on a vehicle 210. Detection of the reflection from the point 240 of the emitted light beam 242 by the LiDAR sensor 120 enables the determination of a distance from the LiDAR sensor 120 to the point 240. The LiDAR sensor 120 also records a directional parameter that defines a position of the point 120. In certain embodiments, the directional parameter comprises an elevation and a rotational value, e.g., spherical coordinates, associated with the vector direction of light beam 242, defined in the coordinate system 122 of the LiDAR sensor 120. In certain embodiments, the directional parameter comprises a “height” and a rotational angle, e.g., cylindrical coordinates, of the point 240 in the coordinate system 122 of the LiDAR sensor 120. In certain embodiments, the directional parameter comprises “x,” “y,” and “z” locations, e.g., Cartesian coordinates, of the point 240 in the coordinate system 122 of the LiDAR sensor 120.

FIG. 3 illustrates an exemplary LiDAR system 300, according to some aspects of the disclosed technology. An exemplary LiDAR sensor 310 has multiple light-emitters (not visible in FIG. 3) arranged in a vertical array that emit the array of light beams 324, wherein light beam 322 is a single light beam emitted by one of the array of light emitters. In certain embodiments, the array of light emitters is arranged such that each emitter emits light along a vector having a position and orientation within the coordinate system of the LiDAR sensor 310. In certain embodiments, the orientation for any particular measurement is partially determined by a rotational displacement 330 from a reference vector 314 fixedly defined in the coordinate system of the LiDAR sensor 310. In certain embodiments, all emitters in the vertical array share a common rotational displacement 330. In certain embodiments, each emitter has its own rotational displacement 330. In certain embodiments, the orientation of each emitter for any particular measurement is partially determined by an elevation parameter 332, e.g., an angular displacement in a vertical plane from a reference vector 316 that rotates with the array of emitters. The LiDAR sensor 310 also comprises one or more detectors (not visible in FIG. 3) that detect the reflected light of each of the emitters.

FIG. 4 illustrates an exemplary data frame 400 that comprises point cloud data generated by a LiDAR system, according to some aspects of the disclosed technology. In certain embodiments, this data frame 400 is provided by the LiDAR sensor 310 to a communicatively coupled device, e.g., a processor. The data structure is consistent with the raster file format used for graphic images, i.e., columns 410 and rows 420. Each cell in the column-by-row matrix is a point data set. In certain embodiments, each column 410 is associated with a rotational displacement 330, or a time associated with that rotational displacement 330, and the cells of that column are respectively associated with the array of emitters. In certain embodiments, the columns are arranged in order of rotational position, e.g., column 412 is a reference rotational angle and column 414 is the last rotational angle before the array returns to the reference rotational angle. Each column 410 has a “top” point data set 424 and a “bottom” point data set 422, with the number of cells in the column 410 consistent with the number of range-finder light emitters of the LiDAR sensor. In certain embodiments, each row 420 across the data frame 400 is associated with a single common emitter.

LiDAR sensors collect a huge amount of data. The Pandar64 sensor, for example, includes a vertical array of 64 laser diodes and rotates a complete 360 degrees. A LIDAR sensor can take a set of measurements by each emitter at each incremental rotational step. For an example of 64 range-finder light emitters arranged in a vertical array (not visible in FIG. 3) and 1600 rotational steps of the vertical array, a 360-degree scan generates approximately 100,000 point data sets. In certain embodiments, a complete 360-degree scan generates a data frame 400. To continue the example, if each point data set has fields totaling 96 bits, the data frame 400 contains fields for approximately 10,000,000 bits. If the LiDAR sensor performs 10 scans per second, it generates a data stream of approximately 100 megabits/second. This requires a high-bandwidth wireless communication channel from the AV to a remote data system, if uncompressed.

Point cloud data is conventionally stored in .DAT files with a common datatype, e.g., a 32-bit floating point field, large enough to contain the largest parameter of the data set. This results in a very large file and, consequently, requires a high-bandwidth communication channel to transmit LiDAR data in near-real time.

A point data set comprises one or more parameters, e.g., a distance, a rotational displacement, a time, an elevation parameter, a reflectance, and a color. In certain embodiments, a color is represented as red-green-blue (RGB) values. Certain data is defined over every point data set, e.g., range and height. Other data is common to multiple point data sets, e.g., the angle of rotation of the LiDAR sensor 120 at which the point data was measured, which is common to all the rangefinders of the LiDAR sensor 120. In certain embodiments, parameters common to a column are contained only in a single point data set of the column.

In certain embodiments, the datatype selected for the field that will store the value of each parameter is selected to minimize the size of the field while providing acceptable accuracy. A parameter having a large range and requiring high accuracy will require a suitable datatype, e.g., 32-bit floating point field, while a color parameter may have a low accuracy requirement, e.g., an 8-bit unsigned field.

A point data set may be empty, e.g., no light was reflected from the light beam emitted at the column rotation/time by the emitter associated with that row. In certain embodiments, this results in a sparse data frame that favors use of a file format having a compression algorithm that is efficient for sparse data sets.

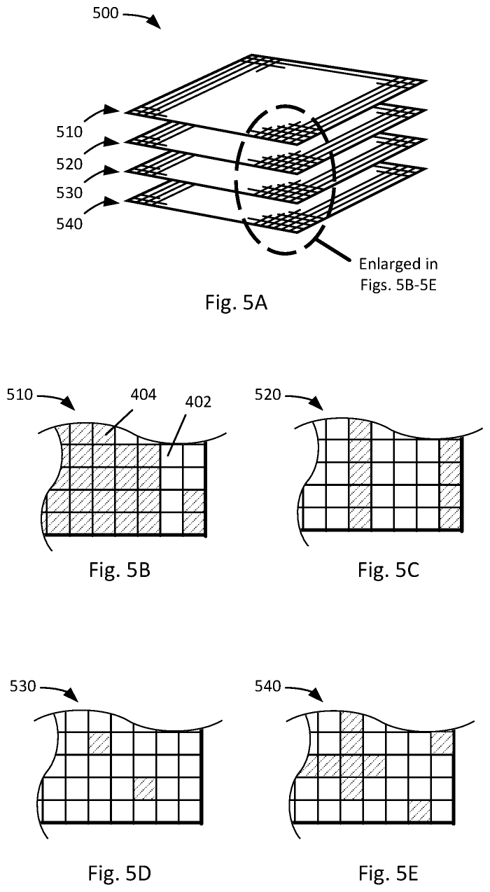

FIG. 5A illustrates a second exemplary data structure 500 of LiDAR data, according to some aspects of the disclosed technology. The data structure 500 comprises one or more data frames, e.g., data frames 510, 520, 530, 540. The data frames 510, 520, 530, 540 are of identical structure and the cells in each frame having the same row and column position are associated. In certain embodiments, the corresponding point data sets of each data frame 510, 520, 530, 540 are populated from data received from a single observation of a single range-finder of the LiDAR sensor. In certain embodiments, the parameters of the point data sets are separated by type, with each parameter being stored in a particular data frame. For example, the distance parameter of each pint data set is stored in the respective cell of frame 510 while the reflectance is stored in the respective cell of frame 540.

FIGS. 5-B-5E represent various examples of data distribution in a data frame. A cross-hatched cell contains data. A white cell is empty or contains only a “null” character.

FIG. 5B is an example of a dense data frame, i.e., a majority of the cells have data.

FIG. 5C is an example of a data frame wherein only certain columns contain data, with the intervening columns completely empty.

FIG. 5D is an example of a very sparse data frame wherein only a few cells have data.

FIG. 5E is an example of a sparse data frame wherein the cells having data are not distributed in a predictable manner. The cells containing data may be clumped or isolated

In certain embodiments, each frame 510, 520, 530, 540 is separately compressed. Each frame 510, 520, 530, 540 may have a different distribution of data in the cells. In certain embodiments, a different compression algorithm is used for one or more of the frames 510, 520, 530, 540, e.g., based, in part, on the distribution of data in the cells of the respective frame.

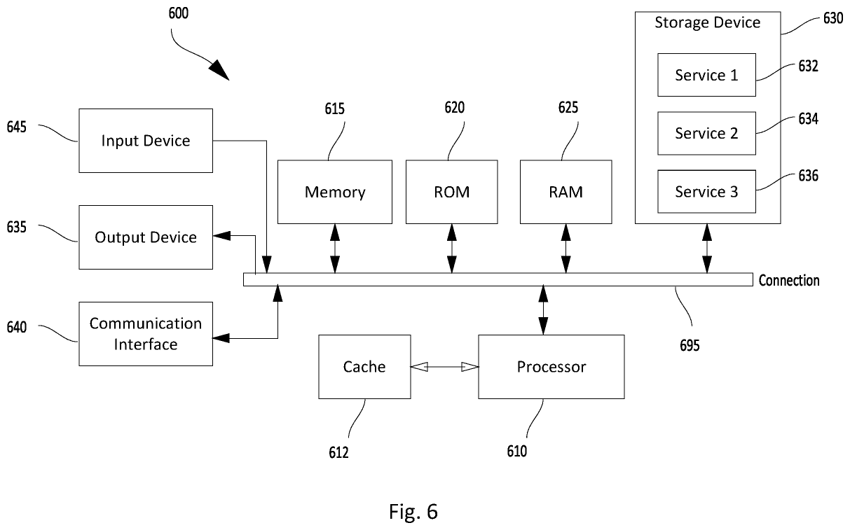

FIG. 6 illustrates an exemplary processor-based system 600, according to some aspects of the disclosed technology. The system 600 can be any computing device or any component thereof in which one or more components of the system 600 are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

What is claimed is:

1. An apparatus for compressing a point cloud, comprising:
a processor; and
a non-transitory computer-readable storage medium coupled to the processor and comprising instructions that, when loaded into the processor and executed, cause the processor to:
receive point cloud data from a Light Detection And Ranging (LiDAR) sensor coupled to an Autonomous Vehicle (AV);
format a portion of the received point cloud data according to a raster-graphic image file standard to create a data frame; and
compress the data frame using a lossless compression algorithm.

2. The apparatus of claim 1, wherein the raster-graphic image file standard is selected from the group consisting of:
Portable Network Graphics (PNG);
Graphics Interchange Format (GIF);
Tag Image File Format (TIFF);
WebP;
High Efficiency Video Coding (HEVC);
High Efficiency Image Format (HEIF);
Advanced Video Coding (AVC); and
Joint Photographic Experts Group (JPEG) 2000.

3. The apparatus of claim 2, wherein the raster graphic-image file standard is PNG.

4. The apparatus of claim 1, wherein:
the LiDAR sensor comprises a first coordinate system;
the point cloud data comprises a plurality of point data sets respectively associated with a plurality of points in an environment surrounding the AV;
each point data set comprises a 3D position of the associated point defined in the first coordinate system;
a second coordinate system is fixedly defined with respect to the AV; and
a third coordinate system is fixedly defined in the environment.

5. The apparatus of claim 4, wherein each point data set comprises:
a distance from the LiDAR sensor to the respectively associated point; and
a directional parameter defining a vector from the LiDAR sensor to the respectively associated point.

6. The apparatus of claim 4, wherein the instructions further cause the processor to transform the 3D positions of the plurality of points in the point cloud data from the first coordinate system into the second coordinate system before the data frame is compressed.

7. The apparatus of claim 6, wherein the instructions further cause the processor to transform the 3D positions of the plurality of points in the point cloud data from the second coordinate system into the third coordinate system before the data frame is compressed.

8. A computer-implemented method for compressing a point cloud, comprising:
receiving point cloud data from a Light Detection And Ranging (LiDAR) sensor coupled to an Autonomous Vehicle (AV);
formatting a portion of the received data according to a raster-graphic image file standard to create a data frame; and
compressing the data frame using a lossless compression algorithm.

9. The apparatus of claim 8, wherein the raster-graphic image file standard is selected from the group consisting of:
Portable Network Graphics (PNG);
Graphics Interchange Format (GIF);
Tag Image File Format (TIFF);
WebP;
High Efficiency Video Coding (HEVC);
High Efficiency Image Format (HEIF);
Advanced Video Coding (AVC); and
Joint Photographic Experts Group (JPEG) 2000.

10. The apparatus of claim 9, wherein the raster graphic-image file standard is PNG.

11. The apparatus of claim 8, wherein:
the LiDAR sensor comprises a first coordinate system;
the point cloud data comprises a plurality of point data sets respectively associated with a plurality of points in an environment surrounding the AV;
each point data set comprises a 3D position of the associated point defined in the first coordinate system;
a second coordinate system is fixedly defined with respect to the AV; and
a third coordinate system is fixedly defined in the environment.

12. The apparatus of claim 11, wherein each point data set comprises:
a distance from the LiDAR sensor to the respectively associated point; and
a directional parameter defining a vector from the LiDAR sensor to the respectively associated point.

13. The apparatus of claim 11, wherein the instructions further cause the processor to transform the 3D positions of the plurality of points in the point cloud data from the first coordinate system into the second coordinate system before the data frame is compressed.

14. The apparatus of claim 11, wherein the instructions further cause the processor to transform the 3D positions of the plurality of points in the point cloud data from the second coordinate system into the third coordinate system before the data frame is compressed.

15. A non-transitory computer-readable storage medium comprising instructions for compressing a point cloud that, when loaded into a processor and executed, cause the processor to:
receive point cloud data from a Light Detection And Ranging (LiDAR) sensor coupled to an Autonomous Vehicle (AV);
format a portion of the received data according to a raster-graphic image file standard to create a data frame; and
compress the data frame using a lossless compression algorithm.

16. The apparatus of claim 15, wherein the raster-graphic image file standard is selected from the group consisting of:
Portable Network Graphics (PNG);
Graphics Interchange Format (GIF);
Tag Image File Format (TIFF);
WebP;
High Efficiency Video Coding (HEVC);
High Efficiency Image Format (HEIF);
Advanced Video Coding (AVC); and
Joint Photographic Experts Group (JPEG) 2000.

17. The apparatus of claim 16, wherein the raster-graphic image file standard is PNG.

18. The apparatus of claim 15, wherein:
the LiDAR sensor comprises a first coordinate system;
the point cloud data comprises a plurality of point data sets respectively associated with a plurality of points in an environment surrounding the AV;
each point data set comprises a 3D position of the associated point defined in the first coordinate system;
a second coordinate system is fixedly defined with respect to the AV; and
a third coordinate system is fixedly defined in the environment.

19. The apparatus of claim 18, wherein the instructions further cause the processor to transform the 3D positions of the plurality of points in the point cloud data from the first coordinate system into the second coordinate system before the data frame is compressed.

20. The apparatus of claim 19, wherein the instructions further cause the processor to transform the 3D positions of the plurality of points in the point cloud data from the second coordinate system into the third coordinate system before the data frame is compressed.
